(19) United States
(12) Patent Application Publication
(10) Pub. No.: US 2003/0038088 A1
(43) Pub. Date: Feb. 27, 2003

(54) Filter element

(76) Inventors: Geert Denys, Horebeke (BE); Geert Devooght, Koekelare (BE)

Correspondence Address: FOLEY AND LARDNER, SUITE 500, 3000 K STREET NW, WASHINGTON, DC, 20007, US

(21) Appl. No.: 10/203,925

(22) PCT Filed: Feb. 14, 2001
(86) PCT No.: PCT/EP01/01591

(30) Foreign Application Priority Data
Feb. 23, 2000 (EP) 00200625.2

(51) Int. Cl. B01D 39/20

(52) U.S. Cl. 210/767; 210/493.1; 210/510.1

(57) ABSTRACT

A high temperature liquid or gas filter element is provided, comprising a pleated sintered metal fiber fleece. This sintered metal fiber fleece is positioned and squeezed between two or more parts of an external wall of the filter element. This to close the pleat openings, and so preventing by-pass of non-filtered liquid or gas.

### FIELD OF THE INVENTION

The present invention relates to a high temperature filter element, comprising a sintered metal fiber fleece and a method to provide such filter element.

### BACKGROUND OF THE INVENTION

High temperature resistant filter elements comprising sintered metal fiber fleeces are known in the art.

Different pleating geometries are known. Usually, the sintered metal fiber filter medium is pleated providing pleats of which the pleating lines run substantially parallel to each other so providing sintered metal fiber walls to the pleats. These pleats have several pleat openings which are to be closed in order to guide the gas or liquid via an inlet pleat opening, through the sintered metal fiber walls to an outlet pleat opening, which is positioned on the other side of the sintered metal fiber filter media.

The pleat openings are often closed and sealed by gluing, welding, roll forming or pressing the edges of the pleated sintered metal fiber fleece to the external wall or to the endcaps of the filter element. Since the filter element is used at high temperatures, the connection and sealing is often broken due to thermal shocks or different thermal coefficients of expansion of parts being connected to each other.

### SUMMARY OF THE INVENTION

It is an object of the invention to provide a high temperature filter element, which comprise a pleated sintered metal fiber fleece, of which the pleat openings are closed in an alternative way, reducing the risk on breaking of the connection and sealing between sintered metal fiber fleece and external wall or endcap of the filter element.

It is also an objective of the invention to provide a method to produce such a high temperature filter element comprising a pleated sintered metal fiber fleece.

The filter element is to be part of a filter system, which has an inlet, via which a liquid or a gas to be filtered is provided to the filter element, and an outlet, via which a filtered liquid or gas is evacuated from the filter element

A filter element as subject of the invention comprises a sintered metal fiber fleece, pleated according to several pleating lines. Each pleat comprises two sintered metal fiber walls, limited by three pleating lines, and one or more pleat openings which are to be closed and sealed to prevent gas or liquid to flow from the inlet of the filter system to the outlet of the filter system without passing through the sintered metal fiber walls. This is a so-called by-pass of non-filtered liquids or gas.

According to the invention, the filter element comprises one or more external walls, which close these pleat openings, so preventing undesired by-passes.

Since the filter is intended to be used on high temperatures, the external walls are preferably made out of metal, e.g. steel.

According to the present invention, the external wall comprising at least two parts, hereafter called a upper and a lower part. The edge of the pleat openings is to be positioned and squeezed between those two parts. Therefor, the edge of the upper part, coming into contact with the pleated sintered metal fiber fleece has a waved shape, identical to the waved shape of the edge of the pleat openings due to the pleating. The edge of the lower part, coming into contact with the pleated sintered metal fiber fleece has also a waved shape, identical to the waved shape of the edge of the pleat openings due to the pleating. The pleated sintered metal fiber fleece is positioned and squeezed between upper and lower part of the outer wall, in such a way that the pleat openings are closed by the waves on the edges of the two parts. The upper part, pleated sintered metal fiber fleece and the lower part are connected to each other by e.g. laser welding, plasma welding, TIG-welding or resistance welding. This welding is done preferably at the outer side of the outer wall. Due to the compressibility of the sintered metal fiber fleece, the leakage of high temperature gas or liquid towards the exterior of the filter element is minimized, if not prevented.

To further avoid the risk on leakage, the filter element may be mounted in a second external wall, which fit closely to this first external wall of the filter element, which positions and squeezes the sintered metal fiber fleece.

A more specific filter element as subject of the invention is provided by pleating a sintered metal fiber fleece contertina-like in such a way that the pleating lines extend from a central axis towards an external wall of the filter element. This external wall encloses the central axis. Each pleat so comprises one pleat opening providing an outer waved shape edge which is to be closed by this external wall, where a second pleat opening extends toward this central axis in an open core area, providing an inner waved shape edge.

Such filter element has the advantage that is has a high filter surface/volume ratio. A filter surface/volume ratio of more than 0.25 mm²/mm³ may be obtained. Preferably, a filter surface/volume ratio of more than 0.3 mm²/mm³, or even more than 0.5 mm²/mm³ may be obtained, still having a filter with reasonable pressure drop and filtering properties.

Pleat openings extending outwards are closed by an outer wall comprising two parts, between which the sintered metal fiber fleece is positioned and squeezed, as described above.

The inner edge of the pleat openings extending towards the central axis may be closed by applying an other external wall, comprising at least two parts and which squeezes the edges of this pleat openings, extending towards the central axis, in a similar way. A second, close fitting external wall may be used here to prevent leakage towards the open core area.

An alternative to close the open core area uses a sintered metal fiber tube, with an outer diameter that is minimally the diameter of the open core area. This sintered metal fiber tube is inserted in the open core area. This sintered metal fiber tube is then pressed against the edge of the pleat openings with one or more cylindrical or conical elements. This can be done by inserting a cylinder of tube in this sintered metal fiber tube, provided that the outer diameter of this cylinder or tube is slightly larger than the inner diameter of the sintered metal fiber tube. If necessary, end parts may be mounted, e.g. screwed , on this cylinder or tube to fix the cylinder or tube.

Two slightly conical parts are brought into the sintered metal fiber tube, one at each side of the tube and with the small diameter pointing inwards the sintered metal fiber tube. The conical shape is chosen in such a way that the smallest diameter of the cone is smaller than the inner diameter of the sintered metal fiber tube, whereas the largest diameter of the conical part is slightly larger than the inner diameter of the sintered metal fiber tube. The height of the conical parts is half of the length of the sintered metal fiber tube. Both conical parts are forced into the sintered metal fiber tube till they meet halfway inside the sintered metal fiber tube, where they are connected to each other, e.g. by pressing, welding or gluing. The conical parts force the sintered metal fiber tube outwards against and partially in the pleat openings. The pleat openings of the sintered metal fiber fleece are closed and sealed by the sintered metal fiber tube.

A person skilled in the art understands that the external wall may be divided in more than two parts, between which the pleated sintered metal fiber fleece is positioned and squeezed.

According to the specific use of the filter element, different sintered metal fiber fleece may be used to provide appropriate filtration properties. Stainless steel sintered fleeces are preferred. Stainless steel fibers may e.g. be bundle drawn or shaved, with fiber diameters of ranging from 1 μm to 100 μm. If required, different layers of sintered metal fiber fleece may be used, one on top of the other.

The alloy of the metal fibers is to be chosen in order to resist the working circumstances of the filter element. Stainless steel fibers out of AISI 300-type alloys, e.g. AISI 316L are preferred in case temperatures up to 360° C. are to be resisted. Fibers based on INCONEL®-type alloys such as INCONEL®601 or HASTELLOY®-type alloys such as HASTELLOY® HR may be used up to 500° C., respectively 560° C. Fibers based on Fe—Cr—Al alloys may be chosen to resist temperatures up to 1000° C. or even more.

Equivalent diameter is to be understood as the diameter of a radial cut of an imaginary round fiber, having an identical surface as the radial cut of the fiber under consideration.

Filter elements as subject of the invention can be used to filter exhaust gases of combustion engines, e.g. to trap the soot particles. They may be used as a carrying element for catalysts, e.g. in the exhaust system of combustion engines.

### BRIEF DESCRIPTION OF THE DRAWINGS

The invention will now be described into more detail with reference to the Accompanying drawings wherein

FIG. 1 shows a top view of a pleated sintered metal fiber fleece.

FIG. 2 shows two parts of an external wall, positioning and squeezing a sintered metal fiber fleece of FIG. 1.

FIG. 3 shows a second external wall used to provide a filter element as subject of the invention.

FIG. 4 shows the closing of the pleat openings extending towards a central axis by means of a sintered metal fiber tube.

FIG. 5 shows another pleated sintered metal fiber fleece.

FIG. 6 shows two parts of an external wall, positioning and squeezing a sintered metal fiber fleece of FIG. 5

FIG. 7 shows a cylindrical pleated sintered metal fiber fleece, of which the pleat openings are closed according to the invention

FIG. 8 shows a second external wall, used to provide a filter element as subject of the invention.

### DESCRIPTION OF THE PREFERRED EMBODIMENTS OF THE INVENTION

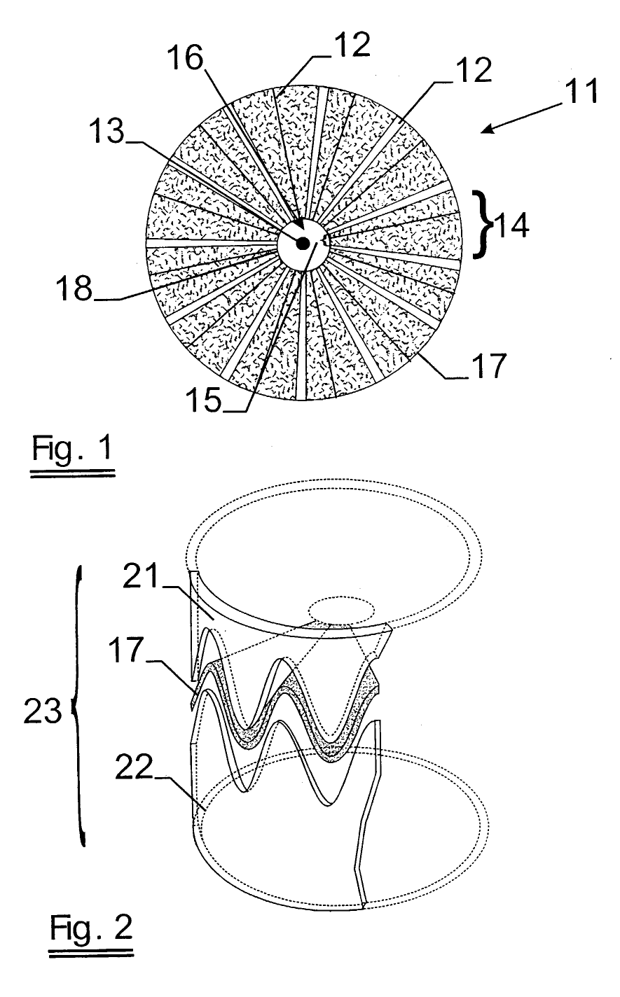

A preferred embodiment of a filter element as subject of the invention comprises a pleated sintered metal fiber fleece as shown in FIG. 1.

A sintered metal fiber fleece 11 is pleated contertina-like in such a way that the pleating lines 12 extend from a central axis 13 outwards. Each pleat so comprises one pleat opening 14 extending outwards, where a second pleat opening 15 extends toward this central axis 13 in an open core area 16. All pleat openings extending outwards provide a waved edge 17. All pleat openings extending towards the open core area provide a waved edge 18.

As shown in FIG. 2, the outer edge 17 of the pleated sintered metal fiber fleece is positioned and squeezed between a upper part 21 and a lower part 22 of the external wall 23. Upper and lower part are formed at one side to the wave shape of the pleated sintered metal fiber fleece, occurring at the outer edge 17. Upper part 21, outer edge 17 and lower part 22 are mounted and pressed to each other.

They are permanently connected to each other by welding them to each other. This welding is preferably done at the outer side of the outer wall.

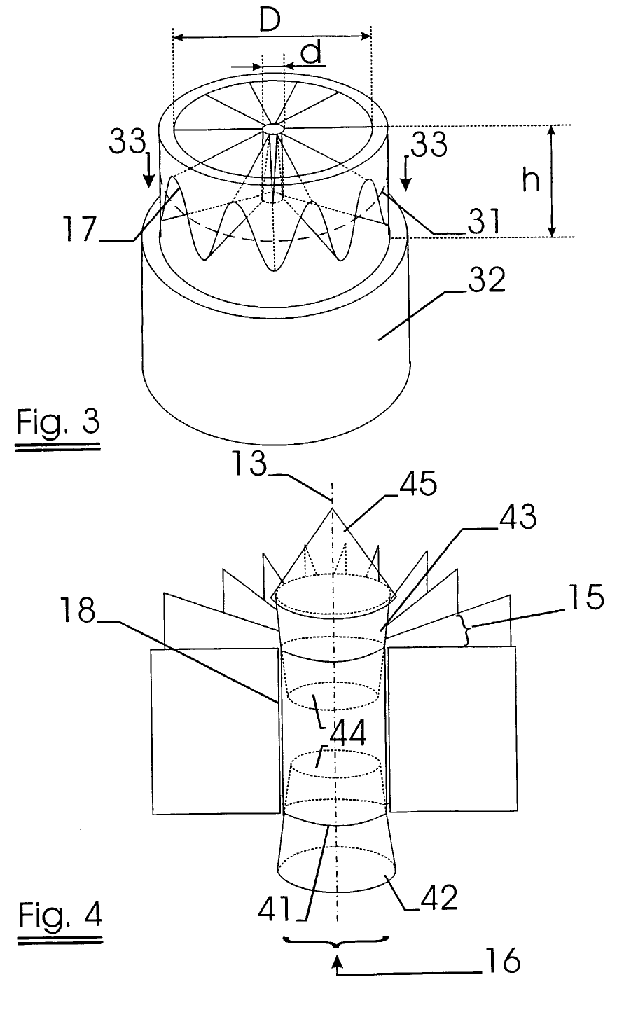

As shown in FIG. 3, laser welding, plasma welding TIG-welding or resistance welding can be applied round the periphery of the external wall, following the waved shape of the sintered metal fiber fleece 17, or by following a circle 31 round the outer wall, coming into contact with the upper and lower part several times.

To prevent eventual leakage of gas or liquid through the outer wall via the sintered metal fiber fleece, a second external wall 32 may be used. The filter element is pressed in a close fitting second external wall 32, as indicated by arrows 33. Eventual leakage via the extension of the sintered metal fiber fleece through the external wall is hereby prevented.

Pleat openings extending towards the central axis can be closed in a similar way.

As a preferred embodiment, a filter element as in FIG. 3 was provided, having different dimensions. As shown in TABLE I, high filter surface/volume (R1) and medium volume/filter volume (R2) was obtained. As filter medium, a sintered metal fiber fleece made out of stainless steel fibers having an equivalent diameter of 35 μm was used. The sintered metal fiber fleece has a thickness of 1.25 mm.

TABLE I

| D | d | H | Volume | Surface | Thickness | Ratio | |
|---|---|---|---|---|---|---|---|
| (mm) | (mm) | (mm) | (mm³) | fleece (mm²) | (mm) | R1 | R2 |
| 110 | 55 | 50 | 356363 | 190000 | 1.25 | 0.533 | 0.666 |
| 100 | 50 | 200 | 1178063 | 625000 | 1.25 | 0.531 | 0.663 |
| 60 | 30 | 35 | 74218 | 40000 | 1.25 | 0.539 | 0.674 |
| 110 | 27 | 50 | 446525 | 141000 | 1.25 | 0.316 | 0.395 |
| 100 | 25 | 200 | 1472578 | 471000 | 1.25 | 0.320 | 0.400 |
| 60 | 15 | 35 | 92772 | 30000 | 1.25 | 0.323 | 0.404 |

The filter surface/volume ratio (R1) is the total surface of the filter medium, divided by the total volume of the filter element, in which the filter surface (or filter medium) is comprised.

The medium volume/filter volume ratio (R2) is the total volume of the filter medium, divided by the total volume of the filter element, in which the filter surface (or filter medium) is comprised.

An alternative method to close pleat openings extending towards the central axis is shown in FIG. 4. A sintered metal fiber tube 41 is inserted in the open core area 16. The external diameter of the sintered metal fiber tube is minimally equal to the diameter of this open core area. Two slightly conical parts 42 and 43 are brought in the sintered metal fiber tube, the smallest diameter pointing inwards of the sintered metal fiber tube. This smallest diameter is slightly smaller than the inner diameter of the sintered metal fiber tube. The largest diameter of the conical parts is slightly larger than the inner diameter of the sintered metal fiber tube. Their smallest end surfaces 44 meet approximately in the middle of the sintered metal fiber tube, where both conical parts are connected to each other, e.g. by welding, gluing or pressing. Eventually, the top 45 of the element 43, pointing towards the inlet of the filter element, may be conical to further improve the flow distribution. The openings are closed since the conical parts force the sintered metal fiber tube partially in the openings and force the edge firmly against the inner side of the sintered metal fiber tube.

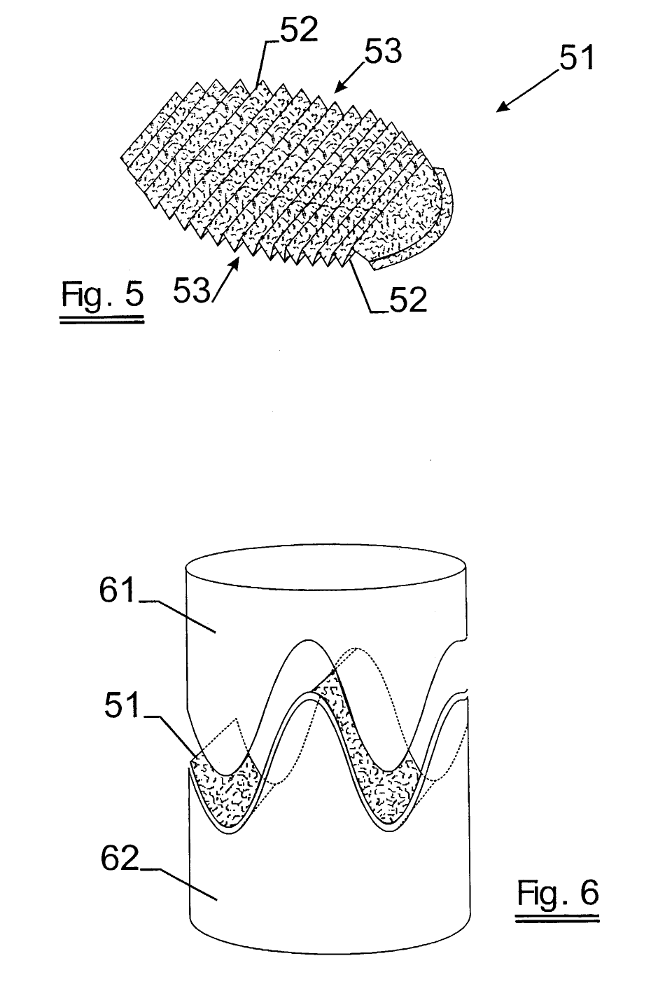

Another embodiment is shown in FIG. 5 and 6. A sintered metal fiber fleece 51 is pleated applying pleating lines 52 that are parallel to each other. The pleat openings 53 are closed and sealed by positioning and by squeezing the pleated sintered metal fiber fleece 51 between upper part 61 and lower part 62 parts of the external wall.

They are permanently connected and sealed to each other by welding them to each other. This welding is preferably done at the outer side of the outer wall.

Laser or resistance welding can be applied round the periphery of the external wall, following the waved shape of the sintered metal fiber fleece 51, or by following a circle round the outer wall, coming into contact with the upper and lower part several times.

To prevent eventual leakage of gas or liquid through the outer wall via the sintered metal fiber fleece, a second external wall may be used. The filter element is pressed in a close fitting second external wall. Eventual leakage via the extension of the sintered metal fiber fleece through the external wall is hereby prevented.

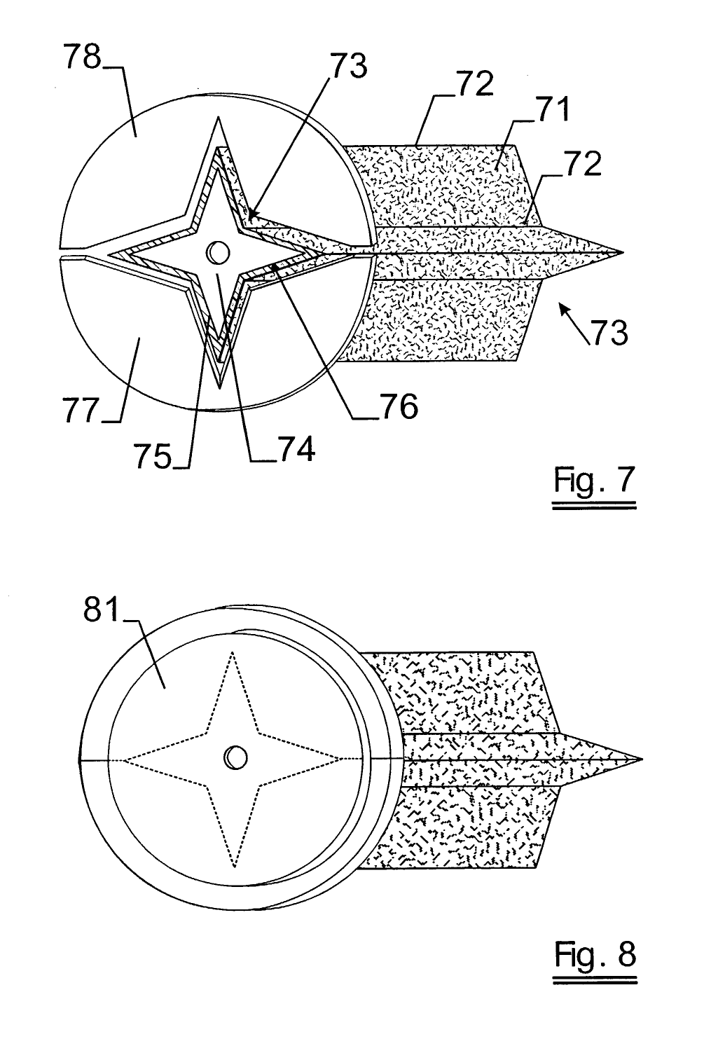

An other embodiment is shown in FIG. 7 and FIG. 8, where a sintered metal fiber fleece 71 is pleated in a cylindrical way, comprising pleating lines 72 which are essentially parallel to each other.

The pleat openings 73, at each side of the cylinder shape, are to be closed by two external walls, one at each side of the cylinder. This can be done by inserting a lower part 74 of the external wall at the inner part of the pleated sintered metal fiber fleece, in order to allow the edge 75 of this lower part to fit with the waved sha pe 76 of the pleated sintered metal fiber fleece 71. A second and third upper part of the external wall 77 and 78, each having an edge which fit with a part, e.g. half of the circumference of the pleated sintered metal fiber fleece 71 are used to position and squeeze the pleated sintered metal fiber fleece between the three parts of the external wall. External wall and sintered metal fiber fleece are welded to each other. The waved shape of the sintered metal fiber fleece may be covered by a second external wall 81, being a plate which is mounted on the external wall, e.g. by welding.

The other pleat openings, at the other side, may be closed by an other external wall in similar way.

A person skilled in the art understands that other embodiments, having different outer geometry, are obtainable in a similar way.

During use of the filter element, the pleats will be kept in their shape as originally introduced. The connection of the sintered metal fiber fleece with the outer wall as subject of the invention will prevent the pleats of collapsing due to the application of the filter.

1. A filter element for filtering high temperature gas or liquid, comprising an external wall comprising at least two parts, a pleated sintered metal fiber fleece pleated according to pleating lines and providing a waved shape edge, characterized in that each of said parts of said external wall has a side which has a waved shape, said wave shaped side fitting with a part of said wave shaped edge of said pleated sintered metal fiber fleece, said waved shape edge being squeezed between said wave shaped sides of said parts of said external wall.

2. A filter element as in claim 1, for which said parts of said external wall and said sintered metal fiber fleece are welded together.

3. A filter element as in claim 1 or 2, for which said external wall is closely fit into a second external wall.

4. A filter element as in claims 1 to 3, for which said pleating lines extend from a central axis towards said external wall.

5. A filter element as in claim 4, said pleat openings extend towards said central axis providing an inner edge, characterized in that a sintered metal fiber tube is pressed against said inner edge.

6. A filter element as in claim 4, said several pleat openings extending towards said central axis providing an inner edge, characterized in that a sintered metal fiber tube is pressed against said inner edge by two conical parts, one of said conical parts being brought into said sintered metal fiber tube at each side with smallest diameter pointing inwards of said sintered metal fiber tube, and both said conical parts being connected to each other.

7. Use of a filter element as in claim 1 to 6 as a soot particle filter.

8. Use of a filter element as in claim 1 to 6 as a catalyst carrier.

9. A method of providing a filter element for filtering high temperature gas or liquid, comprising the steps:
providing a pleated sintered metal fiber fleece, pleated according to pleating lines and providing pleat openings of which edges form a waved shape edge;
providing an external wall comprising at least two parts, each part having a side which has a waved shape, said wave shaped side is to fit with a part of said wave shaped edge of said pleated sintered metal fiber fleece;
closing pleat openings by squeezing said waved shape edge between said wave shaped sides of said parts of said external wall.

10. A method of providing a filter element for filtering high temperature gas or liquid, comprising the steps:
providing a pleated sintered metal fiber fleece, pleated according to pleating lines and providing pleat openings of which edges form a waved shape edge and an inner edge, formed by said pleat openings extending towards an open core area;
providing an external wall comprising at least two parts, each part having a side which has a waved shape, said wave shaped side is to fit with a part of said wave shaped edge of said pleated sintered metal fiber fleece;
closing pleat openings extending outwards by squeezing said waved shape edge between said wave shaped sides of said parts of said external wall;
inserting a sintered metal fiber tube, with an outer diameter minimally equal to the diameter of said open core area, in said open core area;
inserting one or more cylindrical or conical elements in sintered metal fiber tube, so pressing sintered metal fiber tube against inner edge.

11. A method of providing a filter element for filtering high temperature gas or liquid, comprising the steps:
providing a pleated sintered metal fiber fleece, pleated according to pleating lines and providing pleat openings of which edges form a waved shape edge and an inner edge, formed by said pleat openings extending towards an open core area;
providing an external wall comprising at least two parts, each part having a side which has a waved shape, said wave shaped side is to fit with a part of said wave shaped edge of said pleated sintered metal fiber fleece;
closing pleat openings extending outwards by squeezing said waved shape edge between said wave shaped sides of said parts of said external wall;
inserting a sintered metal fiber tube, with an outer diameter minimally equal to the diameter of said open core area, in said open core area
inserting two slightly conical parts in the sintered metal fiber tube with smallest diameter side of said conical part pointing inwards said sintered metal fiber tube; said conical part having a smallest diameter slightly smaller than the inner diameter of said sintered metal fiber tube, a largest diameter slightly larger than said sintered metal fiber tube and a height equal to half of the length of the sintered metal fiber tube;
connecting said smallest side of said conical parts to each other by welding at middle of said sintered metal fiber tube.

12. A method of providing a filter element for filtering high temperature gas or liquid as in claim 9 to 11, comprising the additional steps of applying a second close fitting external wall to prevent leakage of gas or liquid to the external via said sintered metal fiber fleece.
